(19) United States
(12) Patent Application Publication
(10) Pub. No.: US 2013/0297995 A1
(43) Pub. Date: Nov. 7, 2013

(54) Data Recording Apparatus, Data Recording System, Data Recording Method, And Program

(71) Applicants: SONY CORPORATION, Tokyo (JP); SONY DADC CORPORATION, Tokyo (JP)

(72) Inventors: Shinobu Hayashi, Shizuoka (JP); Toshihiko Senno, Kanagawa (JP)

(73) Assignees: SONY DADC CORPORATION, Tokyo (JP); SONY CORPORATION, Tokyo (JP)

(21) Appl. No.: 13/869,515

(22) Filed: Apr. 24, 2013

(30) Foreign Application Priority Data
May 1, 2012 (JP) 2012-104335

(51) Int. Cl. G06F 11/08

(52) U.S. Cl. CPC G06F 11/08
USPC 714/807

(57) ABSTRACT

A data recording apparatus includes a storage unit, a control unit, and a card interface unit. The storage unit stores master data being original data of data to be recorded on a card-type medium. The control unit reads out the master data from the storage unit and executes a recording processing control of the read-out master data with respect to the card-type medium. The card interface unit installs the card-type medium therein and executes data recording processing. Further, the control unit executes, in parallel to recording processing of the master data with respect to the card-type medium, error verification processing of the master data to which the verification value stored in the storage unit is applied, and performs a control of stopping the recording processing of the master data with respect to the card-type medium when an error is detected.

### BACKGROUND

The present disclosure relates to a data recording apparatus, a data recording system, a data recording method, and a program. The present disclosure relates, in particular, to a data recording apparatus, a data recording system, a data recording method, and a program, that enable early detection of occurrence of a data write error and error reduction.

As media to record images, audio, or programs of a game and the like, many disk-like media such as a digital versatile disc (DVD) and Blu-ray disc (BD) have been utilized. In recent years, the use of card-type memories such as a flash memory has increased rapidly.

When a huge number of disks storing the same content are produced, stamping processing utilizing a stamper based on a master disk recording the content can continuously manufacture the huge number of many disks.

However, in the case of the flash-memory type media, copying using a stamper as in the disk manufacturing processing cannot be performed.

Therefore, for example, when a huge number of card-type media recording the same content such as the same game program are manufactured, it is necessary to individually execute content writing processing on each card.

In practice, for example, a data recording apparatus including a plurality of slots into which about 20 cards can be inserted is used to perform the following processing. Specifically, the data recording apparatus reads in write data being master data from a storage medium such as a hard disk, and outputs the read in data to each card and write the read-in data on the card.

Note that such parallel writing processing for card-type media is described in, for example, Japanese Patent Application Laid-open No. 2000-259775.

However, in some cases, an error occurs in data written on a card in such a step. In actual manufacturing processes, for example, error checks are often performed in a final step after all data is written on cards. Specifically, data is individually read out from the cards on which the data has been written and compared with master data read out from a hard disk.

However, even when such error checks are performed, for example, if an error occurs in the master data itself read out from the hard disk and data including the error is written on a card, the master data and the data written on the cards include the same error. Therefore, the error is not detected. In this case, cards storing the data including the error can be distributed, sold, and shipped.

### SUMMARY

In view of the above-mentioned problem, for example, it is desirable to provide a data recording apparatus, a data recording system, a data recording method, and a program, that enable error reduction and early detection of occurrence of an error in data recording processing with respect to a card-type medium such as a flash memory.

According to a first embodiment of the present disclosure, there is provided a data recording apparatus including:

a storage unit configured to store master data being original data of data to be recorded on a card-type medium;

a control unit configured to read out the master data from the storage unit and execute a recording processing control of the read-out master data with respect to the card-type medium; and

a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected.

Moreover, in the data recording apparatus according to the first embodiment of the present disclosure, the card-type medium includes a flash memory as a data storage element.

Moreover, in the data recording apparatus according to the first embodiment of the present disclosure, the card interface unit is configured to be able to perform parallel recording processing with respect to a plurality of card-type media, and the control unit is configured to perform a control of stopping parallel recording processing of the master data with respect to a plurality of card-type media when an error is detected in the error verification processing.

Moreover, in the data recording apparatus according to the first embodiment of the present disclosure, the control unit is configured to read out, from the storage unit, a cyclic redundancy check (CRC) code generated based on the master data, as a verification value recorded corresponding to the master data, and to execute the error verification processing of the master data based on the read-out CRC code.

Moreover, in the data recording apparatus according to the first embodiment of the present disclosure, the control unit is configured to read out, from the storage unit, a message digest algorithm 5 (MD5) code generated based on the master data, as a verification value recorded corresponding to the master data, and to execute the error verification processing of the master data based on the read-out MD5 code.

According to a second embodiment of the present disclosure, there is provided a data recording system including:

a production management data generation unit configured to generate production management data corresponding to master data being original data of data to be recorded on a card-type medium;

a master data verification value generation unit configured to generate a verification value with respect to the master data; and

a data recording apparatus configured to execute recording processing of the master data with respect to the card-type medium, the data recording apparatus including

a storage unit configured to store the master data,

a control unit configured to read out the master data from the storage unit, and execute a recording processing control of the read-out master data with respect to the card-type medium, and

a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected.

Moreover, in the data recording system according to the second embodiment of the present disclosure, the card-type medium includes a flash memory as a data storage element.

Moreover, in the data recording system according to the second embodiment of the present disclosure,

the production management data generation unit is configured to set at least a product identifier (ID) corresponding to the master data and a label ID being an identifier of a label to be attached to the card-type medium, and to store the product ID and the label ID in a production management server.

Moreover, in the data recording system according to the second embodiment of the present disclosure, the master data verification value generation unit is configured to generate a plurality of different verification values with respect to the master data.

Moreover, in the data recording system according to the second embodiment of the present disclosure,

the master data verification value generation unit is configured to generate a cyclic redundancy check (CRC) code and a message digest algorithm 5 (MD5) code based on the master data.

According to a third embodiment of the present disclosure, there is provided an information processing apparatus including a control unit configured to input master data and execute a recording processing control with respect to a medium of input master data, the control unit being further configured to execute, in parallel to recording processing of the master data with respect to the medium, error verification processing of the master data to which a verification value set associated with the master data is applied, and to perform a control of stopping the recording processing of the master data with respect to the medium when an error is detected.

According to a fourth embodiment of the present disclosure, there is provided an information processing apparatus including a control unit configured to output master data, the control unit being further configured to execute, in parallel to output processing of the master data, error verification processing of the master data to which a verification value set associated with the master data is applied, and to perform a control of stopping the output processing of the master data when an error is detected.

According to a fifth embodiment of the present disclosure, there is provided a data recording method to be executed in a data recording apparatus, in which the data recording apparatus including

a storage unit configured to store master data being original data of data to be recorded on the card-type medium,

a control unit configured to read out the master data from the storage unit and execute a recording processing control of the read-out master data with respect to the card-type medium, and

a card interface unit configured to install the card-type medium therein and execute data recording processing, the control unit being further configured to execute, in parallel to recording processing of the master data with respect to the card-type medium, error verification processing of the master data to which a verification value stored in the storage unit is applied, and to perform a control of stopping the recording processing of the master data with respect to the card-type medium when an error is detected.

According to a sixth embodiment of the present disclosure, there is provided a program for executing a data recording control in a data recording apparatus, the data recording apparatus including

a storage unit configured to store master data being original data of data to be recorded on the card-type medium,

a control unit configured to read out the master data from the storage unit and execute a recording processing control of the read-out master data with respect to the card-type medium, and

a card interface unit configured to install the card-type medium therein and execute data recording processing, the program causing the control unit to execute, in parallel to recording processing of the master data with respect to the card-type medium, error verification processing of the master data to which a verification value stored in the storage unit is applied, and to perform processing of stopping the recording processing of the master data with respect to the card-type medium when an error is detected.

Note that the program according to the embodiment of the present disclosure is, for example, a program that can be provided by a storage medium or a communication medium provided to an information processing apparatus and a computer system that can execute various program codes in a computer-readable form. By providing such a program in the computer-readable form, processing according to the program is realized in the information processing apparatus or the computer system.

Other objects, features, and advantages of the present disclosure will become apparent from the following detailed description taken in conjunction with embodiments of the present disclosure and the accompanying drawings. As used herein, a term “system” refers to a configuration of a logical set of a plurality of apparatuses and is not limited to a single casing containing a plurality of apparatuses having respective configurations.

With a configuration according to an embodiment of the present disclosure, an apparatus and a method that enable reduction of a data write error with respect to a card-type medium and early detection of an error of write data are realized.

Specifically, in the configuration in which master data is read out from a storage unit and the read-out master data is recorded on the card-type medium including, for example, a flash memory as a storage element, a verification value recorded corresponding to the master data is read out from the storage unit in parallel to data recording processing with respect to the card-type medium. Error verification processing of the master data read out is executed based on the verification value. If an error is detected, a control of stopping the recording processing of the master data with respect to the card-type medium is performed.

With this configuration, the apparatus and the method that enable reduction of the data write error with respect to the card-type medium and early detection of the error of the write data are realized.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for explaining a configuration example of a data recording apparatus;

FIG. 2 is a flowchart for explaining a sequence of general data recording processing;

FIG. 3 is a diagram for explaining an entire sequence of data recording processing according to an embodiment of the present disclosure;

FIG. 4 is a diagram for explaining processing of a production management data generation unit;

FIG. 5 is a diagram for explaining processing of a master data verification value generation unit;

FIG. 6 is a diagram for explaining processing of the data recording apparatus;

FIG. 7 is a diagram for explaining a configuration example of the data recording apparatus;

FIG. 8 is a flowchart for explaining a processing sequence by the data recording processing; and

FIG. 9 is a hardware configuration example of the data recording apparatus.

### DETAILED DESCRIPTION OF EMBODIMENTS

Hereinafter, a data recording apparatus, a data recording system, a data recording method, and a program according to an embodiment of the present disclosure will be described in detail with reference to the drawings. Note that descriptions will be made in the following order.

1. General Data Writing Processing with Respect to Card-Type Medium

2. Processing Configuration According to Embodiment of Present Disclosure
2-1. Entire Configuration from Reception of Master Data to Data Writing Processing
2-2. Processing of Production Management Data Generation Unit
2-3. Processing of Master Data Verification Value Generation Unit
2-4. Processing and Configuration of Data Recording Apparatus
2-5. Hardware Configuration Example of Data Recording Apparatus

3. Conclusion of Configuration According to Embodiment of Present Disclosure

[1. General Data Writing Processing with Respect to Card-Type Medium]

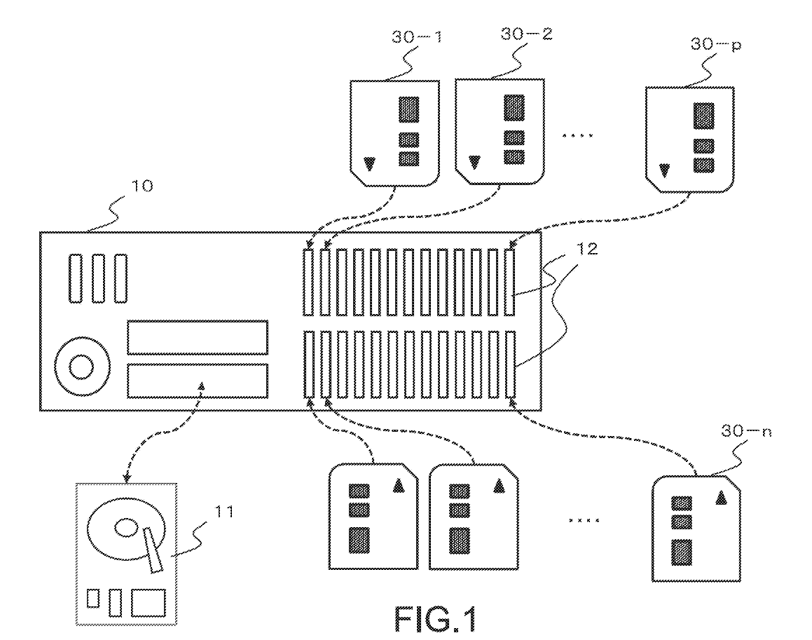

First, general data writing processing with respect to a card-type medium will be described with reference to FIG. 1.

As mentioned above, when media storing content such as movies, images, music, and programs are manufactured, in the case where a medium to be manufactured is a disk, processing utilizing a stamper can produce a huge number of copied disks without the need of sequentially recording substantial data on each disk.

However, in a case of a card-type medium such as a flash memory, processing of actually writing content on each card is necessary.

FIG. 1 shows a configuration example of a data recording apparatus 10 that executes data writing processing.

The data recording apparatus 10 includes a data storage unit 11 recording master data for write data. The data storage unit 11 is formed of a hard disk in this example.

Moreover, the data recording apparatus 10 includes card slots 12 into which card-type media 30-1 to 30-n are inserted. The card-type media 30-1 to 30-n serve as data recording destinations for recording data read out from the data storage unit 11.

Master data of content to be copied, that is, various kinds of content such as images, audio, and programs are stored in the data storage unit 11 of the data recording apparatus 10. The data recording apparatus 10 reads out the master data from the data recording apparatus 10. Further, the data recording apparatus 10 performs processing of recording, in parallel, the read-out data on the plurality of card-type media 30-1 to 30-n inserted into the card slots 12, for example, the card-type media 30-1 to 30-n including flash memories.

With this processing, the same content data as the master data can be stored in a plurality of, in the example shown in the figure, an n-number of card-type media 30-1 to 30-n.

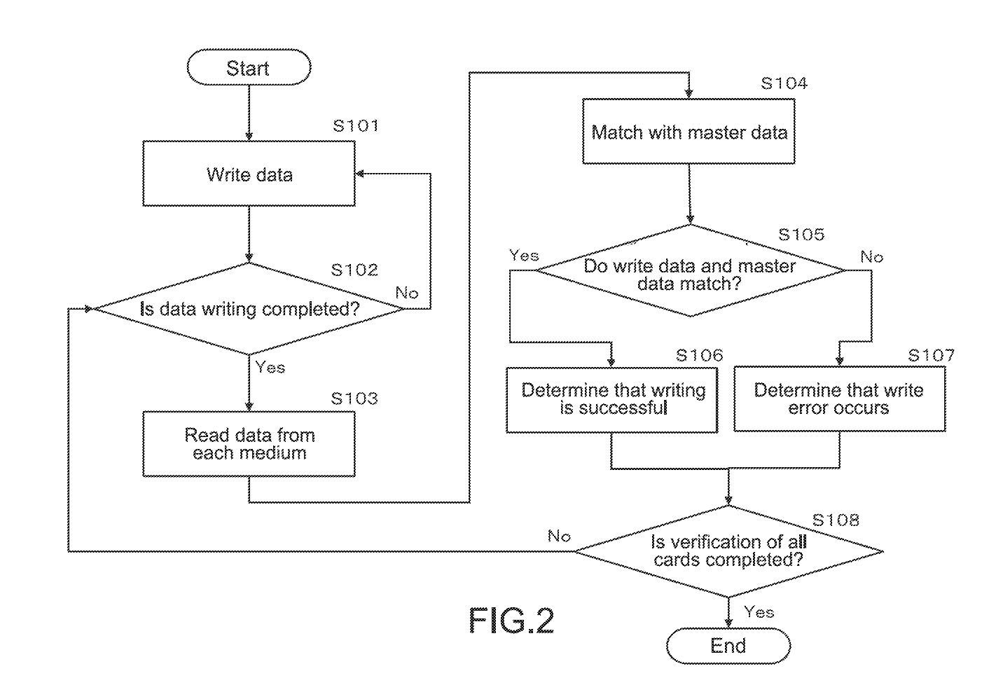

A sequence of data recording processing executed in the data recording apparatus 10 shown in FIG. 1 will be described with reference to a flowchart of FIG. 2.

In Step S101, the master data is read out from the data recording apparatus 10 and stored in the plurality of card-type media 30-1 to 30-n inserted into the card slots 12 in parallel.

In Step S102, when it is confirmed that the data writing is completed, the processing proceeds to Step S103.

In Step S103, data is read out from each of the card-type media. In Step S104, matching processing is performed with respect to the master data.

The master data is data read out from the data storage unit 11 of the data recording apparatus 10.

In Step S105, a determination is made as to whether or not the write data and the master data match. If the write data and the master data match, the processing proceeds to Step S106 and it is determined that the writing is successful.

If the write data and the master data do not match, the processing proceeds to Step S107 and it is determined that a write error occurs.

Note that a card in which a write error occurs is subjected to processing such as re-writing.

However, when such write error determination processing is performed, if the master data itself read out from the data storage unit 11 such as a hard disk includes an error, data including the same error as the master data is written on each card. In this case, the determination processing in Step S105 becomes YES, and an error is not detected and it is determined that the writing is successful.

Note that, the following configurations are known. For example, in one configuration, when data is read from a hard disk utilized as a recording destination for master data, simple error detection processing is performed for each data reading section and automatically corrected. In the other configuration, a substitute area set and utilized without using an error occurrence area as a data recording/reading area after the error is detected. However, even with a hard disk having such a configuration, for example, as data reading and writing are repeated, defect areas increase and substitute areas decrease, with the result that error occurrence data cannot be recovered and is read out as it is.

Regarding such detection and recovery of data errors, similar processing is executed also in data read-out processing from a recording medium or a memory other than the hard disk. However, in any cases, if data reading and writing are repeated, frequency of occurrence of errors gradually increases, and finally an error may be read out without recovering the error.

When such situation occurs, the master data itself read out from the data storage unit 11 such as a hard disk includes an error, and data including the same error as the master data is written on each card.

When such an error occurs, the error cannot be detected in the processing sequence shown in FIG. 2. Also after the error occurs, a huge number of cards recording content including the error are continuously produced.

### [2. Processing Configuration According to Embodiment of Present Disclosure]

Hereinafter, for example, a processing configuration according to the embodiment of the present disclosure for solving the above-mentioned problem will be described.

[2-1. Entire Configuration from Reception of Master Data to Data Writing Processing]

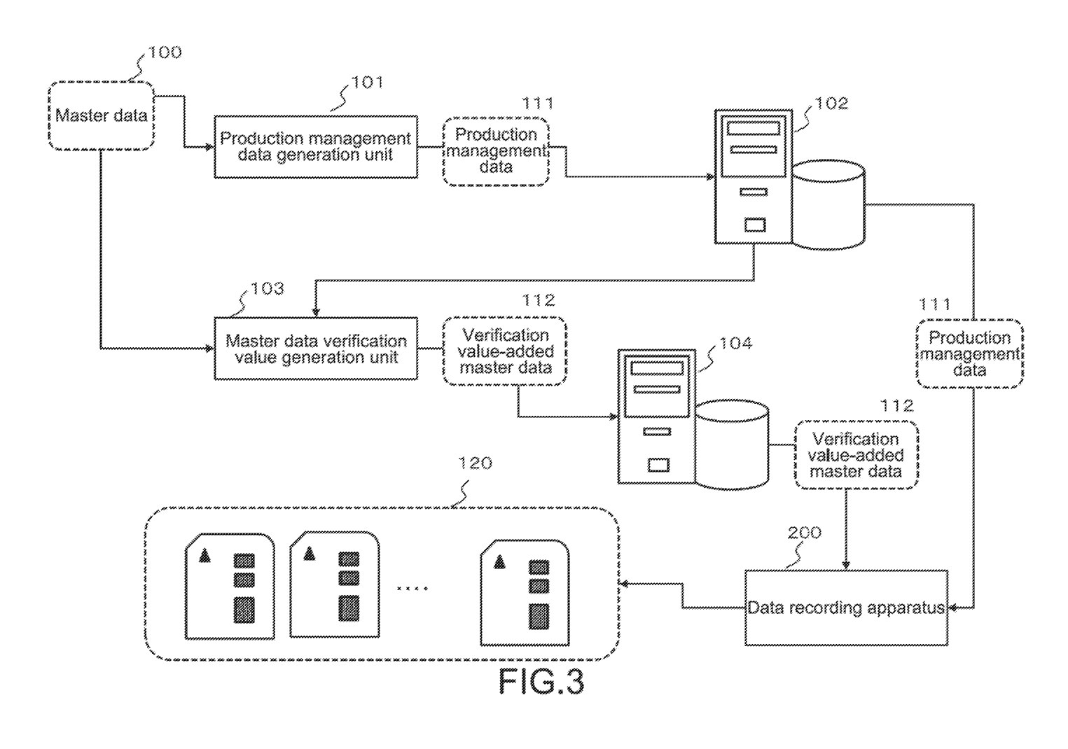

First, an entire processing configuration, that is, an entire processing configuration from reception to data writing processing of the master data will be described with reference to FIG. 3.

FIG. 3 is a diagram for explaining an entire flow of processing of recording master data 100 on a card-type medium 120.

Note that the master data 100 shown in FIG. 3 is master data provided by an external content production company, for example, that is reliable master data certified as content data having no errors. The master data 100 is recorded on a disk such as a DVD and inputted. Alternatively, the master data 100 may be received over a network.

As shown in FIG. 3, the master data 100 is, first, inputted into a production management data generation unit 101.

The production management data generation unit 101 performs setting of production management data, for example, a product identifier (PID) corresponding to the master data 100, setting of a label ID as selection information for a label to be attached to the card-type medium 120 to which content corresponding to the master data is copied and recorded, and the like. Moreover, the production management data generation unit 101 generates master data check data (master data wrong check data) being check data for performing a check for preventing occurrence of an error of a correspondence between master data and order data (PID, label ID, and the like).

The production management data generation unit 101 generates the PID and the label ID, the master data check data (master data wrong check data), and the like as production management data 111 made corresponding to the master data. The production management data generation unit 101 stores the production management data 111 in a production management server 102.

Moreover, the master data 100 is inputted into a master data verification value generation unit 103.

The master data verification value generation unit 103 generates an error verification value with respect to data of the master data 100. The master data verification value generation unit 103 generates, a verification value for error detection, such as a cyclic redundancy check (CRC) code known as an error check code or a message digest algorithm 5 (MD5) code formed of a hash value with respect to inputted data.

The generated verification value is made corresponding to the master data, and stored as verification value-added master data 112 in a content server 104.

Note that a setting in which a plurality of different verification values such as the CRC code and the MD5 code are generated, made corresponding to the master data, and stored is favorably employed.

A data recording apparatus 200 reads out the production management data 111 stored in the production management server 102 and the verification value-added master data 112 stored in the content server 104, and generates many card-type media 120 recording copy data of the master data.

The data recording apparatus 200 records the verification value-added master data 112 read out from the content server 104 in, for example, a recording medium such as a hard disk or a storage unit such as a different memory, which is configured in the data recording apparatus 200.

After that, the data recording apparatus 200 reads out the master data from its own apparatus. The data recording apparatus 200 outputs, in parallel, the read-out master data to the many card-type media inserted into the card slots functioning as a card interface (IF) unit of the data recording apparatus. The data recording apparatus 200 records the copy data of the master data on the card-type medium 120.

Note that, when the data recording on the card-type media inserted into the card slots is completed, similar data writing is further performed after the cards are replaced by other cards. Repeating the processing, the many card-type media recording content are generated.

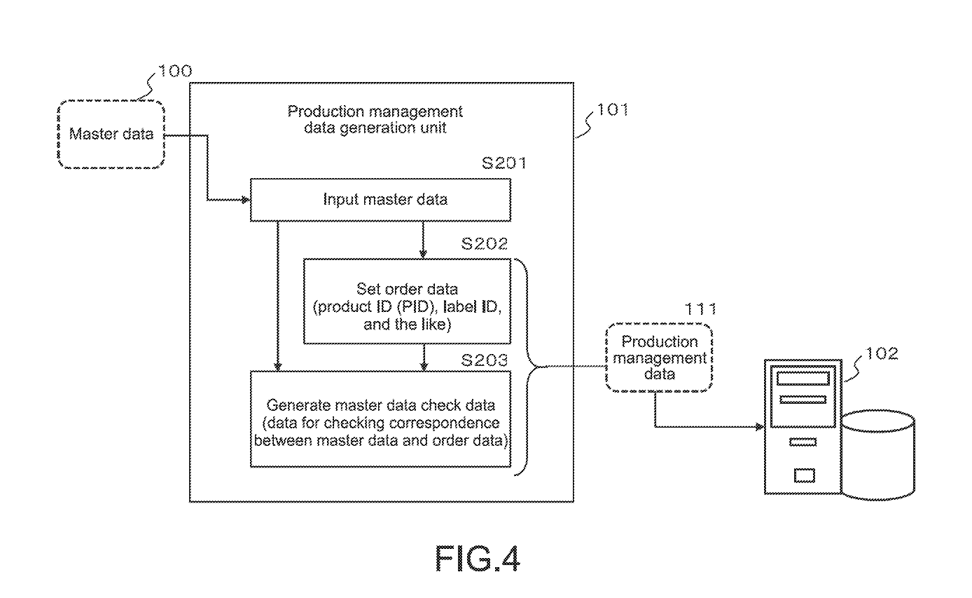

Referring to FIG. 4 and following figures, processing by each of the processing units will be individually described.

### [2-2. Processing of Production Management Data Generation Unit]

First, processing of the production management data generation unit 101 will be described with reference to FIG. 4.

The production management data generation unit 101 first inputs the master data 100 in Step S201 as shown in FIG. 4.

Next, in Step S202, order data corresponding to the inputted master data, for example, a product identifier (PID) or a label ID being a label identifier to be attached to a card is set.

Note that the order data is generated referring to a product specification accompanied with the master data.

Next, in Step S203, the master data check data (master data wrong check data) being check data for performing a check for preventing occurrence of an error of a correspondence between the master data and the order data (PID, label ID, and the like) is generated.

The data generated in Steps S202 and S203 described above, that is, the PID, the label ID, the master data check data, and the like stored as the production management data 111 for the master data in the production management server 102.

### [2-3. Processing of Master Data Verification Value Generation Unit]

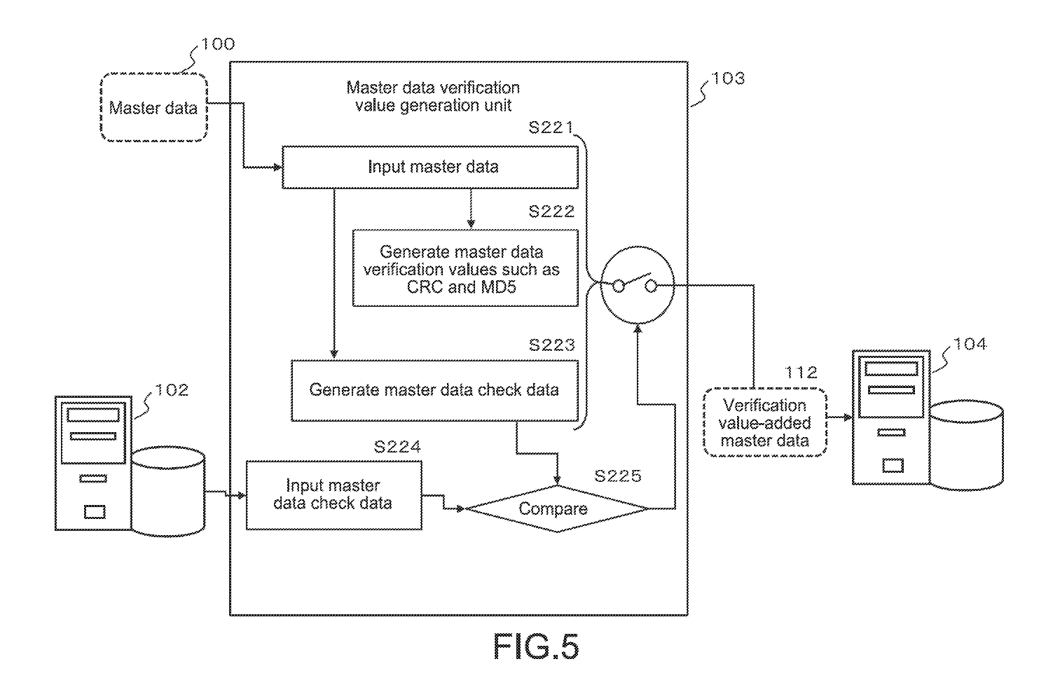

Next, processing of the master data verification value generation unit 103 will be described with reference to FIG. 5.

The master data verification value generation unit 103 first inputs the master data 100 in Step S221 as shown in FIG. 5.

Next, in Step S222, the master data verification value generation unit 103 generates the error verification value with respect to data of the master data 100. Verification values for error detection, for example, a cyclic redundancy check (CRC) code known as an error checking code or a message digest algorithm 5 (MD5) code formed of a hash value with respect to inputted data are generated.

Moreover, in Step S223, processing similar to the generation processing by the production management data generation unit 101 generates master data check data (master data wrong check data).

Moreover, in Step S224, master data check data generated by the production management data generation unit 101 and stored in the production management server 102 is inputted.

In Step S225, the master data check data generated in Step S223 and the master data check data inputted in Step S224 are compared with each other.

If the master data check data and the master data check data do not match, it is determined that a mismatch of the inputted master data or the like occurs. Then, data storing in the content server 104 is stopped.

If the master data check data and the master data check data match, it is determined that the inputted master data is correct data. Then, data storing in the content server 104 is started or continued.

The master data verification value generation unit 103 stores the data generated in Step S221 to S223 as the verification value-added master data 112 in the content server 104.

### [2-4. Processing and Configuration of Data Recording Apparatus]

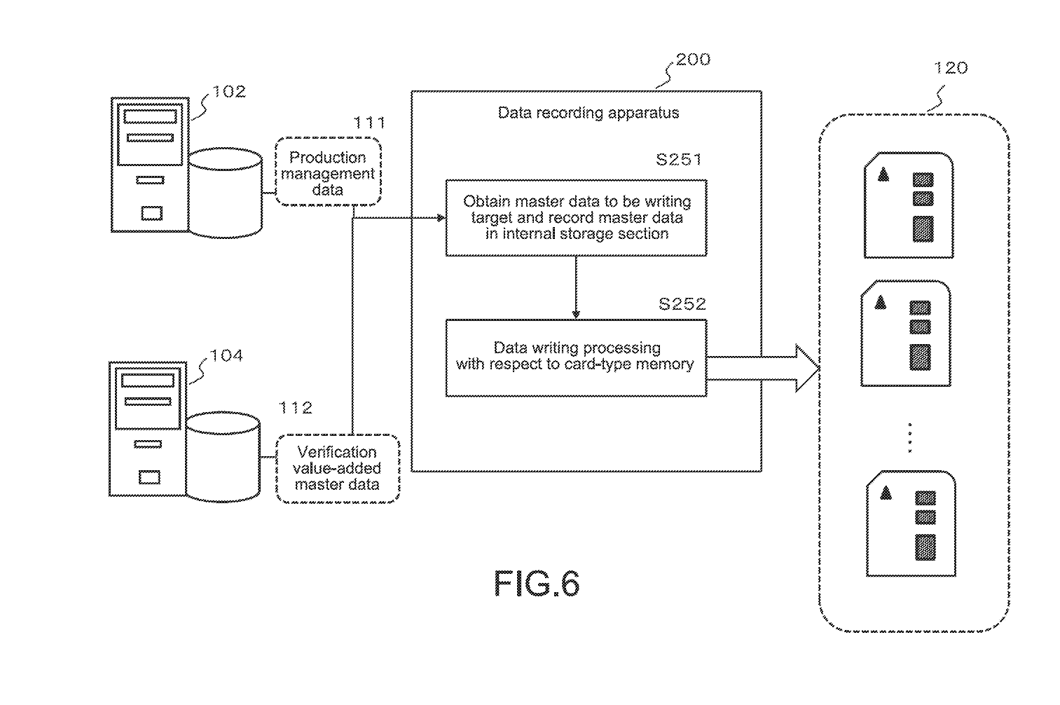

Next, processing and a configuration of the data recording apparatus 200 will be described with reference to FIG. 6 and following figures.

As mentioned above, the data recording apparatus 200 reads out the production management data 111 stored in the production management server 102 and the verification value-added master data 112 stored in the content server 104. The data recording apparatus 200 generates the many card-type media 120 recording the copy data of the master data.

As shown in FIG. 6, in Step S251, the data recording apparatus 200 first obtains the verification value-added master data 112 from the content server 104, and records the verification value-added master data 112 in an internal storage section, for example, a hard disk or a memory such as a random access memory (RAM).

After that, in Step S252, the verification value-added master data 112 stored in the internal storage section of the data recording apparatus 200 is read out, and the data writing with respect to the plurality of card-type media 120 inserted into the card slots of the data recording apparatus 200 is executed. The write data is the copy data of the master data.

Upon the writing, the data recording apparatus 200 subjects the master data read out from the internal storage section of the data recording apparatus 200 to verification processing based on the verification value.

When an error is detected from the read-out master data in the verification processing, the data writing with respect to the card can be immediately stopped.

Note that this processing sequence will be described later.

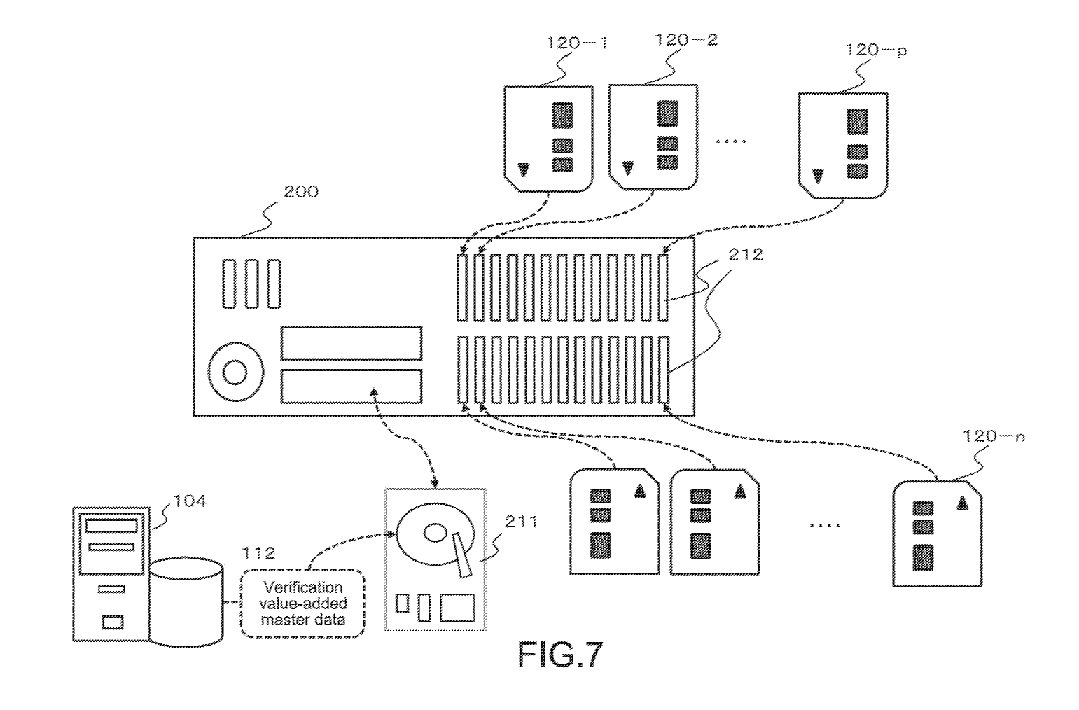

FIG. 7 is a diagram showing a configuration example of the data recording apparatus 200.

The data recording apparatus 200 includes a data storage unit 211. The data storage unit 211 stores the master data to be the write data with respect to the card-type medium, and the verification values thereof, for example, the CRC code or the MD5 code. In the example shown in the figure, the data storage unit 211 is formed of a hard disk.

The data recording apparatus 200 further includes card slots 212. Card-type media 120-1 to 120-n are inserted into the card slots 212. The card-type media 120-1 to 120-n serve as a data recording destination for recording data read out from the data storage unit 211.

The data recording apparatus 200 obtains the verification value-added master data 112 from the content server 104 and stores the verification value-added master data 112 in the data storage unit 211. The verification value-added master data 112 is formed of master data of content to be recorded on the card-type media 120-1 to 120-n and of a verification value thereof. Examples of the content include various kinds of content such as images, audio, and programs.

Moreover, the data recording apparatus 200 reads out the verification value-added master data 112 from the data storage unit 211. Moreover, the data recording apparatus 200 performs processing of recording, in parallel, the read-out data on the plurality of card-type media 120-1 to 120-n inserted into the card slots 212, for example, the card-type media 120-1 to 120-n having flash memories.

With this processing, the same content data as the master data can be stored in a plurality of, in the example shown in the figure, an n-number of card-type media 120-1 to 120-n.

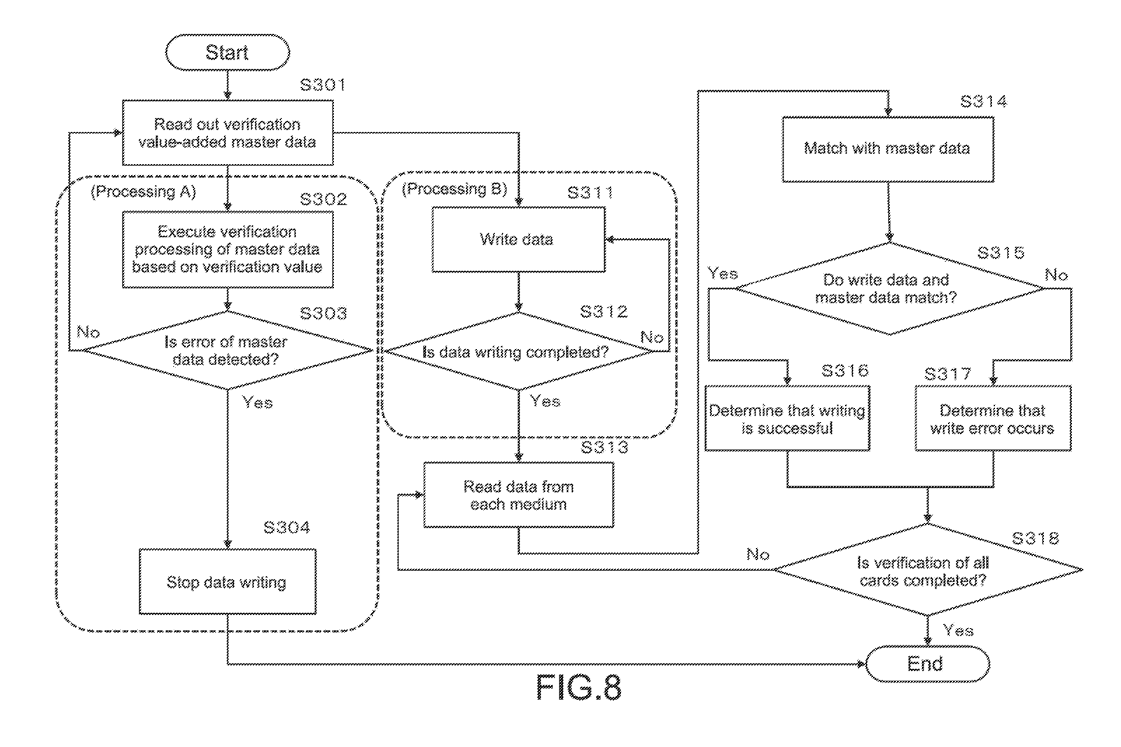

A sequence of data recording processing executed in the data recording apparatus 200 shown in FIG. 7 will be described with reference to a flowchart of FIG. 8.

In Step S301, verification value-added master data is read out from the data storage unit.

Hereinafter, processing A and processing B shown in FIG. 8 are executed in parallel. That is, the following is executed as parallel processing:

(processing A) processing in Step S302 to S304, and

(processing B) processing in Step S311 to S312.

First, the processing A will be described.

In Step S302, the master data and the verification value are obtained from the verification value-added master data read out from the data storage unit. The verification processing of the master data based on the verification value is executed.

For example, when the verification value is the CRC code, an error verification algorithm to which the CRC code is applied based on configuration data of the master data is executed to determine whether or not the read-out master data includes an error.

Similarly, when the verification value is the MD5 code, an error verification algorithm to which the MD5 code is applied, for example, a hash value calculation is performed to determine whether or not the read-out master data includes an error.

Note that, when a plurality of verification values are set, an error check based on each of the plurality of verification values may be performed to determine the presence or absence of an error.

In this case, if it is determined that at least one error occurs in error detection based on each verification value, it is determined that the error is present.

In Step S303, if it is determined that the read-out master data includes no errors, the verification value-added master data is continued to be read out. After that, the verification processing of the master data is executed for each read-out section in Step S302.

In Step S303, if any error is detected from the read-out master data, the processing proceeds to Step S304. The data writing with respect to the card-type medium, which is executed in parallel, is stopped.

With this processing, early detection of an error of the master data itself becomes possible. It becomes possible to prevent occurrence of situation where data including an error is continued to be written in a card as it is.

The processing B is writing processing for copy data of the master data with respect to the card-type medium.

In Step S311, the master data read out from the storage unit of the data recording apparatus is, in parallel, recorded on the plurality of card-type media inserted into the card slots.

Note that, in a step before the data writing processing, a check of a medium type and a check of a medium capacity as a recordable area of a medium are performed as the verification processing for each card. Moreover, format processing is executed and data recording is started. Note that, upon the data recording, not only the master data corresponding to the content substantial data but also management data such as a label ID may be written.

In Step S312, when it is confirmed that the data writing is completed, the processing proceeds to Step S313.

Note that, if an error of the master data is detected in Step S303 during execution of Step S311 to S312 of processing B, the data writing processing in Step S311 is stopped.

Processing following Step S313 is processing similar to the processing after Step S103 of the flow of FIG. 2 that has been described as the example in the related art.

In Step S313, data of each of the card-type media is read out. In Step S314, matching processing with the master data is performed.

The master data is data read out from the storage unit of the data recording apparatus 200.

In Step S315, a determination is made as to whether or not the write data and the master data match. If the write data and the master data match, the processing proceeds to Step S316 and it is determined that the writing is successful.

If the write data and the master data do not match, the processing proceeds to Step S317 and it is determined that a write error occurs.

Note that a card in which the write error occurs is subjected to processing such as re-writing.

The data writing processing according to the flow of FIG. 8 is characterized by parallel execution of two types of processing as follows, which is a difference from the processing described above with reference to FIG. 2. The following processing is executed as parallel processing:

(processing A) processing in Step S302 to S304, and

(processing B) processing in Step S311 to S312.

By executing the parallel processing, an error of the master data itself read out from the storage unit of the data recording apparatus can be immediately detected. By the error detection, it becomes possible to quickly perform a change of the master data or the like without continuing unnecessary data writing processing after that. Further, it becomes possible to reliably and efficiently execute data writing processing without any error.

### [2-5. Hardware Configuration Example of Data Recording Apparatus]

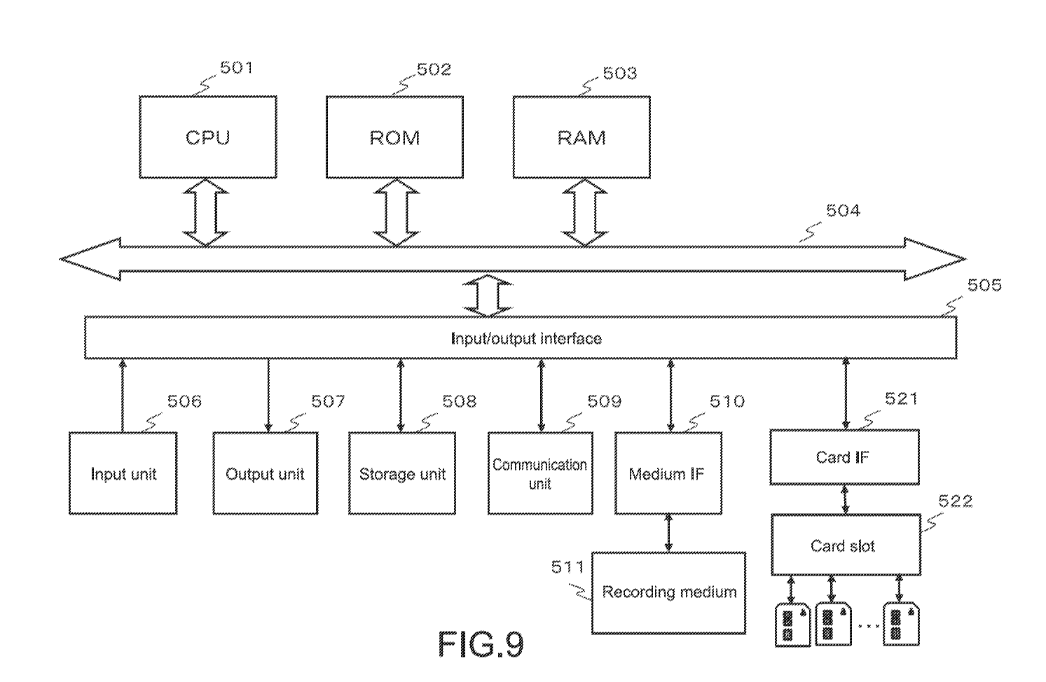

Next, a hardware configuration example of the data recording apparatus will be described with reference to FIG. 9.

FIG. 9 is a diagram showing one example of a hardware configuration of the data recording apparatus that executes data recording with respect to the card-type medium.

A central processing unit (CPU) 501 functions as a data processing unit that executes various types of processing according to programs stored in a read only memory (ROM) 502 or a storage unit 508. For example, the CPU 501 executes processing according to the above-mentioned sequence. Programs, data, and the like to be executed by the CPU 501 are stored in a random access memory (RAM) 503. Those CPU 501, ROM 502, and RAM 503 are connected to one another via a bus 504.

The CPU 501 is connected to an input/output interface 505 via the bus 504. An input unit 506 and an output unit 507 are connected to the input/output interface 505. The input unit 506 includes various types of switches, keyboards, mouse devices, microphones, and the like. The output unit 507 includes a display, a speaker, and the like. The CPU 501 executes various types of processing corresponding to instructions inputted from the input unit 506, and outputs results of the processing to the output unit 507, for example.

The storage unit 508 connected to the input/output interface 505 is formed of, for example, a hard disk. The storage unit 508 stores programs and various types of data to be executed by the CPU 501. A communication unit 509 communicates with an external apparatus over a network such as the Internet and a local area network.

A medium IF 510 connected to the input/output interface 505 drives a recording medium 511 such as a magnetic disk, an optical disc, a magneto-optical disc, and a semiconductor memory such as a memory card, and obtains recording data. A plurality of card-type media are inserted into a card slot 522. Data is written via the card IF 521. For example, the card-type medium is inserted into the card slot 522 and the card IF 521 executes the data recording processing under a control of the CPU 501 functioning as a control unit. Note that, for example, the CPU 501 functioning as the control unit executes processing according to the flow of FIG. 8 described above. That is, in parallel to the recording processing of the master data with respect to the card-type medium, the CPU 501 executes the error verification processing of the master data to which the verification value stored in the storage unit is applied. The CPU 501 executes, for example, processing for stopping the recording processing of the master data with respect to the card-type medium if an error is detected.

Note that, in the above embodiment, the data writing processing example with respect to the card-type medium including the storage element such as a flash memory has been described.

However, the processing according to embodiments of the present disclosure is not limited to the data writing processing with respect to the card-type medium. The processing according to the embodiments of the present disclosure is applicable also to a case where the data writing processing with respect to a medium having other configuration is performed.

Moreover, the processing according to the embodiments of the present disclosure is applicable also to a case where, for example, uploading processing of data to a server, downloading processing of data from the server, or data input/output processing between information processing apparatuses is performed.

Specifically, for example, when processing in which a client downloads data from the server and the data is recorded on the medium of the client, for example, a hard disk (HD) is performed, the client inputs write data for the HD from the server and verification data such as a CRC code corresponding to the data. While performing data verification based on the inputted CRC code, the client performs data writing processing with respect to the HD. If an error is detected in error verification processing based on the CRC code, the client can immediately stop the downloading processing and the recording processing on the HD.

Note that the data verification based on the CRC code or the like may be executed in an apparatus on a data output side, for example, on a server side. Error verification based on the CRC code is executed with the output processing of data on the server side. If an error is detected, a measure of, for example, immediately stopping the data output can be taken.

As a specific apparatus configuration, the processing according to the embodiments of the present disclosure is applicable to, for example, an information processing apparatus as follows.

An information processing apparatus, including

a control unit that inputs master data and executes a recording processing control with respect to a medium of the inputted master data, the control unit executing error verification processing of the master data to which a verification value set associated with the master data is applied in parallel to recording processing of the master data with respect to the medium, and performing a control of stopping the recording processing of the master data with respect to the medium if an error is detected.

Further, for example, processing according to the embodiments of the present disclosure is applicable also to an information processing apparatus having a configuration as follows.

An information processing apparatus, including

a control unit that outputs master data, the control unit executing error verification processing of the master data to which a verification value set associated with the master data in parallel to the output processing of the master data, and performing a control of stopping the output processing of the master data if an error is detected.

### [3. Conclusion of Configuration According to Embodiment of Present Disclosure]

Hereinafter, referring to the specific embodiment, the embodiment of the present disclosure has been described in detail. However, it is obvious that those skilled in the art can achieve a modification or substitute without departing from the gist of the present disclosure. That is, the embodiment of the present disclosure is merely an example and should not be construed as a limitation. For determining the gist of the present disclosure, the scope of claims should be considered.

It should be noted that the technology set forth herein may also take the following configurations, for example.

(1) A data recording apparatus, including:

a storage unit configured to store master data being original data of data to be recorded on a card-type medium;

a control unit configured to read out the master data from the storage unit and execute a recording processing control of the read-out master data with respect to the card-type medium; and

a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected.

(2) The data recording apparatus according to Item (1), in which

the card-type medium includes a flash memory as a data storage element.

(3) The data recording apparatus according to Item (1) or (2), in which

the card interface unit is configured to be able to perform parallel recording processing with respect to a plurality of card-type media, and

the control unit is configured to perform a control of stopping parallel recording processing of the master data with respect to a plurality of card-type media when an error is detected in the error verification processing.

(4) The data recording apparatus according to any one of Items (1) to (3), in which

the control unit is configured to read out, from the storage unit, a cyclic redundancy check (CRC) code generated based on the master data, as a verification value recorded corresponding to the master data, and to execute the error verification processing of the master data based on the read-out CRC code.

(5) The data recording apparatus according to any one of Items (1) to (4), in which

the control unit is configured to read out, from the storage unit, a message digest algorithm 5 (MD5) code generated based on the master data, as a verification value recorded corresponding to the master data, and to execute the error verification processing of the master data based on the read-out MD5 code.

(6) A data recording system, including:

a production management data generation unit configured to generate production management data corresponding to master data being original data of data to be recorded on a card-type medium;

a master data verification value generation unit configured to generate a verification value with respect to the master data; and

a data recording apparatus configured to execute recording processing of the master data with respect to the card-type medium, the data recording apparatus including
a storage unit configured to store the master data,
a control unit configured to read out the master data from the storage unit, and execute a recording processing control of the read-out master data with respect to the card-type medium, and
a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected. (7) The data recording system according to Item (6), in which
the card-type medium includes a flash memory as a data storage element.

(8) The data recording system according to Item (6) or (7), in which

the production management data generation unit is configured to set at least a product identifier (ID) corresponding to the master data and a label ID being an identifier of a label to be attached to the card-type medium, and to store the product ID and the label ID in a production management server.

(9) The data recording system according to any one of Items (6) to (8), in which

the master data verification value generation unit is configured to generate a plurality of different verification values with respect to the master data.

(10) The data recording system according to any one of Items (6) to (9), in which

the master data verification value generation unit is configured to generate a cyclic redundancy check (CRC) code and a message digest algorithm 5 (MD5) code based on the master data.

(11) An information processing apparatus, including

a control unit configured to input master data and execute a recording processing control with respect to a medium of input master data, the control unit being further configured to execute, in parallel to recording processing of the master data with respect to the medium, error verification processing of the master data to which a verification value set associated with the master data is applied, and to perform a control of stopping the recording processing of the master data with respect to the medium when an error is detected.

(12) An information processing apparatus, including

a control unit configured to output master data, the control unit being further configured to execute, in parallel to output processing of the master data, error verification processing of the master data to which a verification value set associated with the master data is applied, and to perform a control of stopping the output processing of the master data when an error is detected.

Moreover, a processing method for the above-mentioned apparatus and system, and a program for the processing are also included in the configurations according to the embodiments of the present disclosure.

Further, the series of processing described herein can be executed by hardware, software, or a composite configuration of the both. If processing by the software is executed, programs recording the processing sequence can be installed into a memory within a computer incorporated in dedicated hardware and executed therein. Otherwise, programs can be installed in a general-purpose computer capable of executing various types of processing and executed therein. For example, the programs can be recorded in a recording medium in advance. Other than installing the programs from the recording medium into the computer, the programs can be received over a network such as a local area network (LAN) and the Internet and installed into the recording medium such as a built-in hard disk.

Note that various types of processing described herein are not limited to be chronologically executed according to the descriptions. The various types of processing may be executed in parallel or individually depending on the processing capacity or necessity of an apparatus that executes the processing. As used herein, a term “system” refers to a configuration of a logical set of a plurality of apparatuses and is not limited to a single casing containing a plurality of apparatuses having respective configurations.

As discussed above, with the configuration according to the embodiment of the present disclosure, an apparatus and a method that enables reduction of a data write error with respect to the card-type medium and early detection of an error of the write data are realized.

Specifically, in a configuration in which the master data is read out from the storage unit and the read-out master data is recorded on the card-type medium including, for example, a flash memory as a storage element, the verification value recorded corresponding to the master data is read out from the storage unit in parallel to the data recording processing with respect to the card-type medium. The error verification processing of the read-out master data is executed based on the verification value. If an error is detected, a control of stopping the recording processing of the master data with respect to the card-type medium is performed.

With this configuration, an apparatus and a method that enable reduction of a data write error with respect to the card-type medium and early detection of an error of the write data are realized.

The present disclosure contains subject matter related to that disclosed in Japanese Priority Patent Application JP 2012-104335 filed in the Japan Patent Office on Mar. 4, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data recording apparatus, comprising:
a storage unit configured to store master data being original data of data to be recorded on a card-type medium;
a control unit configured to read out the master data from the storage unit and execute a recording processing control of the read-out master data with respect to the card-type medium; and
a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected.

2. The data recording apparatus according to claim 1, wherein
the card-type medium includes a flash memory as a data storage element.

3. The data recording apparatus according to claim 1, wherein
the card interface unit is configured to be able to perform parallel recording processing with respect to a plurality of card-type media, and
the control unit is configured to perform a control of stopping parallel recording processing of the master data with respect to a plurality of card-type media when an error is detected in the error verification processing.

4. The data recording apparatus according to claim 1, wherein
the control unit is configured to read out, from the storage unit, a cyclic redundancy check (CRC) code generated based on the master data, as a verification value recorded corresponding to the master data, and to execute the error verification processing of the master data based on the read-out CRC code.

5. The data recording apparatus according to claim 1, wherein
the control unit is configured to read out, from the storage unit, a message digest algorithm 5 (MD5) code generated based on the master data, as a verification value recorded corresponding to the master data, and to execute the error verification processing of the master data based on the read-out MD5 code.

6. A data recording system, comprising:
a production management data generation unit configured to generate production management data corresponding to master data being original data of data to be recorded on a card-type medium;
a master data verification value generation unit configured to generate a verification value with respect to the master data; and
a data recording apparatus configured to execute recording processing of the master data with respect to the card-type medium, the data recording apparatus including
a storage unit configured to store the master data,
a control unit configured to read out the master data from the storage unit, and execute a recording processing control of the read-out master data with respect to the card-type medium, and
a card interface unit configured to install the card-type medium therein and execute data recording processing, the control unit being further configured to execute, in parallel to recording processing of the master data with respect to the card-type medium, error verification processing of the master data to which the verification value stored in the storage unit is applied, and to perform a control of stopping the recording processing of the master data with respect to the card-type medium when an error is detected.

7. The data recording system according to claim 6, wherein
the card-type medium includes a flash memory as a data storage element.

8. The data recording system according to claim 6, wherein
the production management data generation unit is configured to set at least a product identifier (ID) corresponding to the master data and a label ID being an identifier of a label to be attached to the card-type medium, and to store the product ID and the label ID in a production management server.

9. The data recording system according to claim 6, wherein
the master data verification value generation unit is configured to generate a plurality of different verification values with respect to the master data.

10. The data recording system according to claim 6, wherein
the master data verification value generation unit is configured to generate a cyclic redundancy check (CRC) code and a message digest algorithm 5 (MD5) code based on the master data.

11. An information processing apparatus, comprising
a control unit configured to input master data and execute a recording processing control with respect to a medium of input master data, the control unit being further configured to execute, in parallel to recording processing of the master data with respect to the medium, error verification processing of the master data to which a verification value set associated with the master data is applied, and to perform a control of stopping the recording processing of the master data with respect to the medium when an error is detected.

12. An information processing apparatus, comprising
a control unit configured to output master data, the control unit being further configured to execute, in parallel to output processing of the master data, error verification processing of the master data to which a verification value set associated with the master data is applied, and to perform a control of stopping the output processing of the master data when an error is detected.

13. A data recording method to be executed in a data recording apparatus, in which the data recording apparatus including
a storage unit configured to store master data being original data of data to be recorded on the card-type medium,
a control unit configured to read out the master data from the storage unit and execute a recording processing control of the read-out master data with respect to the card-type medium, and
a card interface unit configured to install the card-type medium therein and execute data recording processing, the control unit being further configured to execute, in parallel to recording processing of the master data with respect to the card-type medium, error verification processing of the master data to which a verification value stored in the storage unit is applied, and to perform a control of stopping the recording processing of the master data with respect to the card-type medium when an error is detected.

14. A program for executing a data recording control in a data recording apparatus, the data recording apparatus including
a storage unit configured to store master data being original data of data to be recorded on the card-type medium,
a control unit configured to read out the master data from the storage unit and execute a recording processing control of the read-out master data with respect to the card-type medium, and
a card interface unit configured to install the card-type medium therein and execute data recording processing, the program causing the control unit to execute, in parallel to recording processing of the master data with respect to the card-type medium, error verification processing of the master data to which a verification value stored in the storage unit is applied, and to perform processing of stopping the recording processing of the master data with respect to the card-type medium when an error is detected.
